(19) United States
(12) Patent Application Publication
(10) Pub. No.: US 2006/0022449 A1
(43) Pub. Date: Feb. 2, 2006

(54) Sublimation and scrapbook memory devices

(75) Inventor: Diane L. Peterson, Addison, TX (US)

Correspondence Address: THORPE NORTH & WESTERN, LLP., 8180 SOUTH 700 EAST, SUITE 200, SANDY, UT, 84070, US

(73) Assignee: Atitania Ltd.

(21) Appl. No.: 11/074,327

(22) Filed: Mar. 4, 2005

Related U.S. Application Data
(60) Provisional application No. 60/550,166, filed on Mar. 4, 2004.

(51) Int. Cl. B42F 5/00

(52) U.S. Cl. 281/22

(57) ABSTRACT

A system and method are provided for producing durable scrapbook pages. One operation is supplying a substrate layer. Another operation is configuring a plurality of scrapbook images and text in a computer memory. Then the images and text can be sublimated onto the substrate layer. Finally, two sheets of plastic can be bonded over the substrate layer to form a scrapbook. The substrate layer can be comprised of plastic, nylon or metal sheets.

### CROSS-REFERENCE TO RELATED APPLICATIONS AND CLAIM OF PRIORITY

This Non-provisional application claims the benefit of U.S. Provisional Patent Application No. 60/550,166 filed Mar. 4, 2004.

### BACKGROUND

Most people are sentimental to one degree or another. As a result of this human quality of sentimentality, individuals like to purchase objects that they associate with events or people in their life. For example, when individuals graduate from school training, such as high school or college, quite often they will purchase a class ring. Unfortunately, women do not like class rings because they are quite bulky and relatively expensive. In addition, they are typically not beautiful or a quality jewelry item. This does not mean that women or even men have not had a good school experience but this means they do not like the specific memory item associated with their schooling.

There are also other memory items that individuals like to collect. Examples of these are thimbles, spoons, cups, cards, hats, shirts and similar items that are based on a location a person has visited. Although these items identify a specific location, they do not have any further date markings, manufacturing location markings, or other type of item of interest associated with the goods. Most of the items that are collected by individuals are random odds and ends that are eventually stuffed away in a drawer. The reason they are eventually put in a box is because they are not that beautiful or interesting anyway. Eventually these items collect dust and are discarded. It is unfortunate that these items, which are associated with good memories, are discarded because it would be valuable to have items that could be displayed for many years or that are beautiful and can be mounted on a wall. Even items that are expensive may collect dust or break and then be discarded.

### SUMMARY

A system and method are provided for producing durable scrapbook pages. One operation is supplying a substrate layer. Another operation is configuring a plurality of scrapbook images and text in a computer memory. Then the images and text can be sublimated onto the substrate layer. Finally, two sheets of plastic can be bonded over the substrate layer to form a scrapbook. The substrate layer can be comprised of plastic, nylon or metal sheets.

### DETAILED DESCRIPTION OF EXAMPLE EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### Sublimation and Scrapbook Memory Devices

The present invention includes memory coins and durable scrapbook pages that are made using sublimation processes and plastic printing processes. In the past scrapbooks have been made using paper and then photos are glued to the paper. In addition, lettering, writing, and designs can be written on or glued to the paper or card stock. Durable scrapbook pages using plastic, metal or other stiff synthetic substrates have not been provided in the past. In order to understand how these coins and scrapbook pages are manufactured, a description of how sublimation works is helpful.

Sublimation is the process by which an image printed on paper is transferred to another surface or substrate. Unlike conventional inks, sublimation inks are converted directly from a solid to a gas under heat and pressure, causing them to bond with the fibers of synthetic materials such as polyester. The molecules of the ink revert to a solid state upon cooling, permanently staining the surface of the plastic.

The equipment needed to create sublimation products on a small scale is currently available but of course larger scale equipment and processes are also used. In order to create a wide variety of full color products, a desktop computer, printer, a heat press, and an order of fire retardant plastic can be used. Many brands of fire retardant plastic are scratch, stain, and graffiti resistant, water repellent and UV resistant, and able to withstand long-term interior use without the need for a top coat. One useful size is a 3/32″ thick product is available in both pre-cut blanks and uncut sheet stock. However, any thickness of plastic can be used. In addition, the sublimation process can be applied to metals such as aluminum and brass. Sometimes in sublimation, the material is coated to accept the image.

In order to create the sublimated product, a design is first produced. The design layout can be created using graphics or photo software. This can include adding art and text to personalize the item. Once the design has been generated, then the design can be printed as a mirror image onto high quality inkjet paper using sublimation inks. The next step is transferring the mirror image to the plastic or other synthetic material. The heat press is preheated according to manufacturer's instructions. The transfer is positioned over the synthetic material and under the heat press. The heat press then applies heat and pressure for the appropriate amount of time. Finally, the operator of the press can lift the press and remove the transfer. This results in the design being embedded into the plastic or synthetic material.

This sublimation process can be used to create one of the layers for the coins described above. These coin layers can be metal or plastic and then the coin layer can be combined together with the precious metal layer. For example, games such as checkers and chess can be manufactured using sublimation on game playing pieces that may be combined with the precious metal layer. Sublimation can also be applied to currency or collector's bills. Alternatively, sublimation of plastic can be used when creating credit cards or other mediums for currency exchange.

Another use of sublimated products which provides a valuable product is the sublimation of memory items such as scrapbook pages. Sublimating scrapbook pages creates a durable, long-lasting scrapbook page that can be electronically assembled on a computer and then heat transferred to plastic, nylon, or metal.

The plastic, nylon, or metal sheets are not sold in notebook or scrapbook size and so the sublimation substrate is cut to the size of a scrapbook or notebook. The substrate can be cut before or after the sublimation process takes place.

One embodiment of the scrapbook page creation process is take two sheets of plastic and one sheet of metal. The plastic sheets are sublimated with the designs, photos, text and other scrapbook art and the plastic sheets dry after a certain period of time. Then the metal can be bonded to the two sheets of plastic to create a durable scrapbook sheet. Alternatively, the sublimation can be performed on both sides of a single sheet of plastic. Sublimating on both sides of a sheet of plastic must be done carefully or with machinery created for this specific purpose in order to avoid damaging the first sublimation surface. This type of process can also be used for other memory items such as Christmas ornaments, photo displays, and similar scrapbook configurations.

Another method of creating scrapbook pages on plastic, metal, or any printer materials, is directly printing on the plastic, metal or durable synthetic print material. This can be done using a special purpose printer, which has printer trays that can process specific sizes of plastic sheets and enable both sides of the plastic to be printed upon. Particularly, the printing can be performed on plastic sheets that are the size of 11×8.5, 11×14, 11×17, and other sizes which can be used in scrapbooks. This means that the special purpose printer can have an adjustable tray that can hold multiple scrapbooks size pages. Alternatively, the trays can have multiple slots for the various sizes of plastic or metal sheets.

A method for creating the designs and images that will be sublimated on the substrate can also be used. An electronic template can first be defined for the scrapbook page. Then electronic photos or images can be embedded into the digital form. The photos can be still frames from a video camera, digital photos or scanned paper photos. Then all of the photos and objects on the page can be numbered and their size can be defined for reference purposes. In addition, a background template can be created. The completed image can then be placed on the sublimation template. Next, a laser printer can be used for printing the image on transfer paper or plastic. Then sublimation can take place as described above. In addition, the program can provide a system of combining the sublimation output or direct color printing systems with an engraving from a laser such as a CO2 laser, Yager laser, in a scrapbook.

Thus, the present invention provides pre-assembled scrapbook pages as the output from the computer program. The pre-assembled scrapbook pages can be bound into a book. These pre-assembled pages can be sold individually or in a collection. The invention also allows sets of images, artwork, and text to be gathered as needed for a scrapbook. If the plastic or metal substrates are combined together in a loose-leaf style folder then holes are punched through the sheets so that they can be included in the loose-leaf folder or bound with loops. The folders or bound books can have leather or any other material covers. There can also be engravings attached to the folder or material cover for logos, titles, etc.

The pre-assembled scrapbook pages can be made by printing the pictures on paper using a computer printer. Then a laser engraver can be used to engrave a frame out of different types of material. The frame may be die stamped or any other method for personalization. This method can be used to make pages for coins to be stored in the scrapbook.

The metal or plastic substrate can also be printed on using rubber stamps or rubber stamp molds. The rubber stamp molds can be made from using a laser for customization. The rubber stamp then can have ink applied to the stamp and printed to the respective material. Other molds can be used that are made of acrylic, polymers, or other filling products. Accordingly, a single or double mold can be made with a laser on the acrylic and a graphics imaging program to guide the laser while it is creating the acrylic mold.

Metal molds can also be used for creating the plastic substrate pages. The metal molds are used in die stamping. Metal molds can be injected with plastics to create a custom textured scrapbook page or custom designs on a plastic sheet that can be combined with the sublimation images. Even ceramic molds or wax molding techniques can be used for this purpose.

As discussed, a Yager laser can be used to finish the scrapbook pages, layered coins, or memory objects. The Yager Laser can etch directly on the finished material. The Yager laser can engrave on many metals and other materials directly. This allows the artwork, logos, and other information to be engraved directly on the material. Alternatively, a rotary engraver can be used, but the rotary engravers can handle only vector artwork and text information.

The techniques described above for scrapbooks can also be used for making three-ply plastic sheets for signs, jewelry, ID tags, pet tags, drink coasters, and medical alert tags. Custom jewelry can be made using the three ply plastic and the sublimation and printing techniques described previously. This custom jewelry can use plastic sheets with colors to represent universities, social organizations, companies, and any other entity.

The three-ply plastic can be used to make a coin. This method uses the die stamp method for creating the coin, but then the coin is lasered. The coin can be fully lasered or partially lasered with other technologies applied (i.e., sublimation, direct plastic printing, etc.)

One advantage of using the plastic, metal, paper, and other material for scrapbook pages is that it provides a material that is more durable. In the past, scrapbooks have not been made from such materials because the mindset of the scrapbook community has been to make scrapbook pages out of paper. In addition, for the pre-assembled scrapbook pages out of plastic, metal, and other material to be used in a scrapbook, the pages must have holes punched in them and the pages must be cut to the appropriate size because sheets of plastic with holes that are notebook or loose-leaf sized are not available at retail. In addition, scrapbook pages have been made by clipping out individual photos, paper pieces, and artwork and then gluing those onto a sheet. A commercially available product that enables individuals to create durable scrapbooks has not been available.

In addition, laser matting can be performed for the scrapbook pages. The matting can be cut out using a laser. Then the images and artwork are printed and the laser cut matting is attached over the images.

Collector cards can also be made using the same sublimation, direct printing, or other processes. This provides durable collector cards that can be written on or which may even get wet without any damage. Particularly, the collector cards can be created to remember a trip on a specific airline and create a collection of race cars or interesting planes. In addition, sports cards can be created in the same manner such as basketball cards, baseball cards, hockey cards, etc. The durable cards can even have the client's own pictures and this enables them to act a business cards. The cards can have holes punched in them for use in attaching to other sheets or other ways can be provided to attach the cards to other sheets or books.

There are several ways of making scrapbooks from the durable printed pages. One is creating a solid sheet of material (e.g., plastic or metal) and then using tools to punch holes in the material. Another method of making the scrapbook pages is to create a solid material with holes already formed in the sheet.

A laminate type of scrapbook page can also be created. One layer of the material can be used as a base layer and will have holes punched though the sheet and a second layer can be for a picture or memory items. These are manufactured separately and then can be adhered together to produce the final scrapbook page.

Other alternative embodiments of the scrapbook sheets can use two sided metal matte boards. The scrapbook can also have cover with see-through material. Another method of creating a scrapbook sheet is to print the memory items or pictures on photo type of paper and then the photo paper can be adhered to the durable scrapbook sheet (e.g., plastic). The matte board can become 2 ply or 3 ply material.

Scrapbooks can be die-stamped. A scrapbook can have inserts like picture frames. A scrapbook can have attachments like banners, letters, etc. The coins packages and the collectible cards may be packaged with foods products, restaurant house products, machine names, and individual names.

One product of the present invention is preassembled cards, packages, scrapbooks, and other items to collect. The technology in making and in tracking and any other technology can vary. Logos on the collectibles can be lasered, die stamped, or use any other method to produce logo on a sign or sheet of plastic. All types of business information can go into logo or the logo can stand alone.

Free standing logos can be sublimated on a material layer and adhered to a sign. The layered logo can be attached to sign or held in a slot or frame. The real estate industry can place the logo and information together on a sign. The logo in a sign can be welded to another shape like a square

Additional memory items can be made using tiles and inlays to make pictures in floors and walls. The inlaid tiles and pots can be manufactured by filling them in with paint, stone, plastic, and other materials. It is an inlay look. It can have a protective covering material over the inlay using any protective coating technology or method. Items can be applied to the tile tops and attached using methods known in the art. Cut outs of artwork and other items can be incorporated items onto the tiles.

### Scrapbook

The page can have pre-made holes or the holes can be stamped into the plastic scrapbook pages later. The page can have a fold or may not have a fold. The method of creating the fold or holes can be of any means known to those skilled in the art.

The pages can be die-stamped out using any method or means known to those skilled in the art. No material or technology is made to handle creating scrapbooks using printing techniques or sublimation.

Devices can be created to produce individual cards or scrapbooks like Disney's “dogs tag machine” and Kodak's “photo to a disk”. However, the pre-assembly of the individual scrapbooks is beneficial. The materials, the processes, and other steps needed to make these items are independent. People are not marketing cards and scrapbooks at events where people can purchase on customized cards and scrapbooks to preserve their memories of the event. The individual's information can be added at the time of purchase or later. The cards and scrapbooks can be in any shape.

Memory items can be placed on using tape and can be attached any way. Items can be incorporated in the cards or scrapbooks. An example is a frame to place your pictures in. The method of attaching the card and the information contained on the card are independent. May types of technology can customize the memory items like die stamping, laser, and many more. This customization is for dates, seats, and any other information that is important.

Current scrapbooks and cards can also use any hand written information to be added to the customized sheets. The cards and scrapbooks do not allow this in today's market. Scrapbooks and cards can be attached to any product and in multiple forms. Scrapbooks and cards can have their holes added before sales or after the sales. Scrapbooks and cards can be used with the frame or customized frames to preserve them.

Prepackage scrapbooks and cards give a continuous flow in the story which they are trying to tell. Scrapbooks and cards can be incorporated into the packaging for food products. Example: Hershey almond bar information inside the bar like a card or in the package on the front or inside.

Food product lines can be used as memory foods in remembering an event, vacation visit, or even the name of manufacturing equipment. For example, the food manufacturing equipment can be given human character names. This is a marketing gimmick for a food production line. This equipment produces our memory foods around events.

Another feature of the present invention is preassembly cards and scrapbooks that can be packaged individually or in sets. The packaging of the scrapbooks can take a number of forms such as a plastic case.

The technology in making the cards and scrapbooks can take on a variety of forms. The tracking devices in the cards and scrapbooks can take on various forms. Like the bar codes can be applied to track them in and out of a fair. Cards and scrapbooks can be created with sublimation. The awards programs used with the coins applies to the scrapbooks and cards.

Free standing logos on signs can be attached to existing sign frames or new frames can be created. Real estate and other markets place their logos in the sign with other information. Cost can be cut if the logos are stamped because the signs can be used for multiple agents. The agents can then enter their information separate to the sign.

Logos can be created with any technology like laser, die stamp, or any other method to produce them. The logo can be created where the information is incorporated. All information could go into the logo or the logo can stand alone with information any where around them.

The frame places information on a wire, information in the frame like agents phone number, information in another frame to tell if sold, and foot bar to place the sign in the ground. A pole can be used to hold the logo, a frame can be used for the sold bar, and a foot bar can also be used.

There are many various ways to create standing logos. The sublimation manufacturers are not manufacturing yard signs, real estate signs, etc. The materials are there for the signs, but they do not match the frames and the machines are not big enough to make large signs. I have to make my frame and the cost to create a larger front is cost prohibitive. There are many ways to create these frames and free standing logos. Sublimation is one way for the signs and welding for the frame is one way.

Free standing logos can go in other products like packaging. The signs technology can incorporate new technology in any form. The information can be rearranged in many other ways. It does not take way for the other invention to the sign market.

Using tile, floors, and other floor materials to produce personalized floors, walls, and ceilings. The invention uses any technology to cut out and any fill to produce personalization to floors. This invention uses the laser to cut the material or create a template. The templates are used in sand blasting to create this cut. The cutouts are filled in with other material. This material could be paint, plastic, or any other material. The material can have a coating placed on top of it.

Any technology for the cut the flooring, any technology for the fill, and any technology for the coating. Creating a total customized mall like jewelry making, wood carpenter, etc. to go to get personalized gift at a good cost. I am using removable car to trains and trucks to create them. The invention is also 2-ply and 3-ply matte board for the laser.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for producing durable scrapbook pages, comprising the steps of:
supplying a substrate layer;
configuring a plurality of scrapbook images and text in a computer memory;
sublimating the images and text onto the substrate layer; and
bonding two sheets of plastic over the substrate layer to form a scrapbook page.

2. A method as in claim 1, wherein the supplying step further comprising the step of supplying the substrate layer using plastic, nylon, mylar, vinyl, or metal sheets.

3. A method as in claim 1, wherein the configuring step further comprises the step of providing a computer template for the scrapbook page.

4. A method as in claim 1, wherein the sublimating step generates images and text on both sides of the substrate layer.

5. A method as in claim 1, further comprising the step of preparing the scrapbook page to be attached with other scrapbook pages in a scrapbook.

6. A method as in claim 1, wherein the supplying step comprises supplying a substrate layer the size of a collector's card.

7. A method as in claim 1, wherein the supplying step further comprises predecorating the substrate layer.

8. A method as in claim 7, wherein the predecorating step comprises adding texture to the substrate layer.

9. A method as in claim 1, wherein the additional substrate layers can be cut with lasers and plasma cutters.

10. A method as in claim 1, further comprising the step of superimposing layers of sublimated material over original layers.

11. A durable scrapbook page, comprising:
a substrate layer upon which a plurality of images and text has been sublimated;
a protective covering which can be bonded over the substrate layer when the page is complete; and
one or more attachment points where the scrapbook page may be joined with other scrapbook pages.

12. The invention according to claim 11 further comprising a hole in the substrate layer forming a receptacle.

13. The invention according to claim 12 wherein the receptacle is configured to accept any from the following group: coin, picture, paper, medal, ribbon, currency, ornament, document or other scrapbook compatible memorabilia.

14. The invention according to claim 11 wherein the substrate layer is chosen from the group of: plastic, nylon or metal.

15. The invention according to claim 11 wherein the attachment points are configured to accept bindings from the group of: loops, screws, ribbon, rings, spiral, posts, glue, adhesive, book binding or clips.

16. A method for tracking a piece of memorabilia, comprising:
recording information from an event using memorabilia device;
place a tracking identification code on the memorabilia device;
holding the memorabilia together with holder; and
tracking the identification code in tracking software.

17. A method as in claim 16, wherein the memorabilia device is a scrapbook and the information is applied to the scrapbook page using sublimation.

18. A method as in claim 16, wherein the memorabilia device is held together using a binder.

19. A method as in claim 16, wherein the memorabilia device is a cake card.

20. A method as in claim 16 further comprising the steps of producing memorabilia coins, comprising the steps of:
supplying a substrate layer;
configuring a plurality of coin images and text in a computer memory;
sublimating the images and text onto the substrate layer; and
attaching the substrate layer to the precious metal layer.
